(19) United States
(12) Patent Application Publication
(10) Pub. No.: US 2018/0357963 A1
(43) Pub. Date: Dec. 13, 2018

(54) A PIXEL CIRCUIT, A METHOD FOR DRIVING THE PIXEL CIRCUIT, AND A DISPLAY APPARATUS

(71) Applicant: BOE TECHNOLOGY GROUP CO., LTD.

(72) Inventors: Cuili Gai, Beijing (CN); Baoxia Zhang, Beijing (CN); Ling Wang, Beijing (CN); Yicheng Lin, Beijing (CN); Quanhu Li, Beijing (CN)

(73) Assignee: BOE TECHNOLOGY GROUP CO., LTD., Beijing (CN)

(21) Appl. No.: 15/776,982

(22) PCT Filed: Dec. 11, 2017
(86) PCT No.: PCT/CN2017/115440

§ 371 Date: May 17, 2018

(30) Foreign Application Priority Data
May 16, 2017 (CN) 201710344664.3

(51) Int. Cl. G09G 3/3258; G09G 3/3233

(52) U.S. Cl. CPC G09G 3/3258; G09G 2320/0233; G09G 3/3233

(57) ABSTRACT

The present application discloses a pixel circuit in a display panel. The pixel circuit includes a data-input sub-circuit coupled to a data line and a scan line, an emission-control sub-circuit configured to control a first voltage from a first voltage terminal to be applied to a second node, a reset sub-circuit coupled to a reset port and a reset-control terminal, a capacitor coupled between the first node and the third node to regulate a voltage difference thereof, a light-emitting device coupled to the third node and a second voltage terminal, and a driving sub-circuit coupled to the second node, the first node, and the third node, the driving sub-circuit being configured to drive the light-emitting device to emit light under controls of both the data signal at the first node and the first voltage at the second node.

### CROSS-REFERENCE TO RELATED APPLICATION

This application claims priority to Chinese Patent Application No. 2017103446643, filed May 16, 2017, the contents of which are incorporated by reference in the entirety.

### TECHNICAL FIELD

The present invention relates to display technology, more particularly, to a pixel circuit and a pixel driving method thereof, a display panel, and a display apparatus having the same.

### BACKGROUND

Organic Light Emitting Diode (OLED) draws major interests of researchers on the field of display apparatus. Comparing to Liquid Crystal Display (LCD), it indeed shows many advantages in small power consumption, low cost of manufacture, self-luminous, wide viewing angle, and fast response rate and has been applied in a wide range of products like smart phone, PDA, digital camera, and more. In particular, pixel circuit design is a core technology of OLED display and plays an important role in the R&D of the OLED technology.

### SUMMARY

In an aspect, the present disclosure provides a pixel circuit in a display panel. The pixel circuit includes a data-input sub-circuit coupled to a capacitor and a driving sub-circuit, and configured to transmit a data signal be applied to a control terminal of the driving sub-circuit. The pixel circuit further includes an emission-control sub-circuit coupled to the driving sub-circuit, and configured to supply a first voltage signal be applied to a first terminal of the driving sub-circuit to set a first voltage level at the first terminal. Additionally the pixel circuit includes a reset sub-circuit coupled to capacitor and the driving sub-circuit, and configured to transmit a reset signal be supplied to a second terminal of the driving sub-circuit to set a second voltage level at the second terminal. The driving sub-circuit is configured, after the second terminal being set to the second voltage level, to drive a light-emitting device which is coupled to the second terminal under a control of 1) the data signal applied to the control terminal, 2) the first voltage level set at the first terminal, and 3) the voltage difference between the control terminal and the second terminal regulated by the capacitor.

Optionally, the driving sub-circuit includes a driving transistor having a gate electrode coupled to an output terminal of the data-input sub-circuit, a first electrode coupled to an output terminal of the emission-control sub-circuit, and a second electrode coupled to an output terminal of the reset sub-circuit. The gate electrode is the control terminal, the first electrode is the first terminal, and the second electrode is the second terminal.

Optionally, the data-input sub-circuit includes a first switch transistor having a gate electrode coupled to a scan line configured to be applied with a first control signal, a first electrode coupled to a data line configured to be provided with the data signal, and a second electrode coupled to the control terminal of the driving sub-circuit.

Optionally, the reset sub-circuit includes a second switch transistor having a gate electrode coupled to a reset-control terminal configured to be applied with a third control signal, a first electrode coupled to a reset port configured to be provided with the reset signal, and a second electrode coupled to the second terminal of the driving sub-circuit.

Optionally, the emission-control sub-circuit includes a third switch transistor having a gate electrode coupled to a emission-control terminal configured to be applied with a second control signal, a first electrode coupled to a first voltage terminal configured to be provided with a first voltage signal, and a second electrode coupled to the second terminal of the driving sub-circuit.

Optionally, the light-emitting device includes an organic light-emitting diode having a first electrode coupled to the second terminal of the driving sub-circuit and a second electrode coupled to a second voltage terminal.

Optionally, the data-input sub-circuit includes a first switch transistor. The reset sub-circuit includes a second switch transistor. The emission-control sub-circuit includes a third switch transistor. Each of the first switch transistor, the second switch transistor, and the third switch transistor is an N-type thin-film transistor or N-type MOS transistor.

In another aspect, the present disclosure provides a method of driving a pixel circuit described herein. The method includes applying a third control signal from the reset-control terminal to the reset sub-circuit to transmit a reset signal from a reset port to the second terminal of the driving sub-circuit to set the second voltage level at the second terminal of the driving sub-circuit. Additionally, the method includes applying a second control signal to the emission-control sub-circuit to transmit a first voltage signal to set the first voltage level at the first terminal of the driving sub-circuit. The method further includes applying a first control signal to the data-input sub-circuit to transmit a data signal be applied to the control terminal of the driving sub-circuit. Furthermore, the method includes using the capacitor to stabilize a voltage difference between the control terminal and the second terminal of the driving sub-circuit.

Optionally, the method of applying a first control signal includes setting the first control signal to be at a switch-on voltage level in a reset period, a compensation period, and a data-input period of an operation cycle of the pixel circuit, and setting the first control signal to be at a switch-off voltage level in an emission period of the operation cycle.

Optionally, the method of applying a second control signal includes setting the second control signal to be at a switch-off voltage level in the reset period and the data-input period, and setting to be at a switch-on voltage level in the compensation period and the emission period.

Optionally, the method of applying a third control signal includes setting the third control signal to be at a switch-on voltage level in the reset period, and setting the third control signal to be at a switch-off voltage level in the compensation period, the data-input period, and the emission period.

Optionally, in the reset period the data signal includes a reference voltage being applied to the gate electrode of the driving transistor and the reset signal comprises a reset voltage being applied to the second electrode of the driving transistor. The reset voltage is equal to the reference voltage.

Optionally, in the compensation period the data signal includes a reference voltage being applied to the gate electrode of the driving transistor. The method further includes applying the first voltage signal from the first voltage port to the first electrode of the driving transistor to charge the second electrode of the driving transistor.

Optionally, the second electrode of the driving transistor is charged to a voltage level equal to a first voltage difference between the reference voltage and a threshold voltage of the driving transistor.

Optionally, in the data-input period, the method of using the capacitor includes stabilizing a second voltage difference between the control terminal and the second terminal of the driving sub-circuit equal to the first difference plus a partial voltage level that is equal to the first difference multiplied by a ratio of a capacitance of the capacitor over a sum of the capacitance of the capacitor and an effective capacitance of the light-emitting device.

In yet another aspect, the present disclosure provides a display panel including an array of pixel circuits. Each of which is a pixel circuit described herein coupled to a light-emitting device.

Optionally, each of the array of pixel circuits includes an emission-control sub-circuit having a common emission-control terminal and a reset sub-circuit having a common reset-control terminal.

In still another aspect, the present disclosure provides a display apparatus including a display panel described herein.

### BRIEF DESCRIPTION OF THE FIGURES

The following drawings are merely examples for illustrative purposes according to various disclosed embodiments and are not intended to limit the scope of the present invention.

FIG. 1 is a circuit diagram of a conventional pixel circuit with a 2T1C structure.

FIG. 2 is a structure diagram of a pixel circuit according to an embodiment of the present disclosure.

FIG. 3 is a circuit diagram of a pixel circuit according an embodiment of the present disclosure.

FIG. 4 is a timing diagram of operating the pixel circuit of FIG. 3 according to some embodiments of the present disclosure.

FIG. 5 is a flow chart showing a method of driving a pixel circuit according to some embodiments of the present disclosure.

FIG. 6 is a flow chart showing a method of operating an organic light-emitting diode display panel for displaying image according to some embodiments of the present disclosure.

FIG. 7 is a timing diagram of operating an organic light-emitting diode display panel for displaying image according to some embodiments of the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

Unlike the LCD utilizing a stable voltage to control different brightness, organic light-emitting diode (OLED) is a current-driven device and needs a stable driving current to control light emission. Due to manufacture process variation and device aging and other reasons, a threshold voltage of a driving transistor in the pixel circuit is not uniform among all pixels of an OLED display panel. The non-uniformity of the threshold voltage causes different driving current flowing through different OLED in different pixels, leading to non-uniform brightness thereof and affecting overall image display effect.

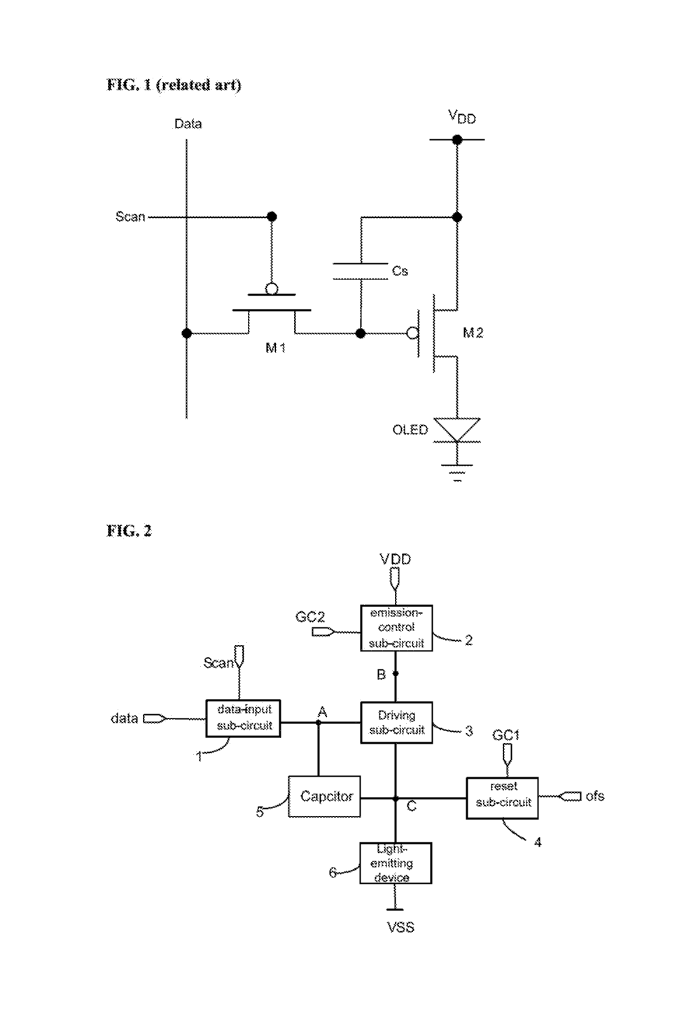

In a conventional pixel circuit having a 2M1C structure, as shown in FIG. 1, the pixel circuit includes a driving transistor M2, a switch transistor M1, and a storage capacitor Cs. When a scan line Scan selects one row (of pixel circuits) and a low voltage signal is inputted from the scan line Scan, the P-type switch transistor M1 is turned on to a conduction state. A voltage from a data line Data is written into the storage capacitor Cs. When this row finishes its scan, the scan line Scan inputs a high voltage signal, the P-type switch transistor M1 is turned off, the voltage stored in the storage capacitor Cs controls the driving transistor M2 to generate a current to drive the OLED of the pixel to emit light during a time in one frame of image. In particular, the driving transistor M2 works in its saturation stage so that the current can be represented in a saturation current formula: I_{OLED}=K(V_{SG}−Vₜₕ)². Here, V_{SG} is a source-to-gate voltage difference, i.e., V_{S}−V_{G}, of the driving transistor M2, K is a structural parameter of the driving transistor, and Vₜₕ is a threshold voltage of the driving transistor M2. It shows that the current I_{OLED} is depended on the threshold voltage Vₜₕ. If Vₜₕ is drifted over time, the current I_{OLED} will change, leading to non-uniformity of pixel brightness.

Accordingly, the present disclosure provides, inter alia, a pixel circuit, a display panel, and a display apparatus having the same, and a pixel driving method thereof that substantially obviate one or more of the problems due to limitations and disadvantages of the related art. In one aspect, the present disclosure provides a pixel circuit. FIG. 2 is a structure diagram of a pixel circuit according to an embodiment of the present disclosure. Referring to FIG. 2, the pixel circuit includes a driving sub-circuit 3, a data-input sub-circuit 1, a reset sub-circuit 4, an emission-control sub-circuit 2, a capacitor 5, and a light-emitting device 6.

The data-input sub-circuit 1 includes an input terminal coupled to a data line (data), a control terminal coupled to a scan line (scan), and an output terminal coupled to a first node A which is coupled to the capacitor 5 and the driving sub-circuit 3. The data-input sub-circuit 1 is configured to transmit a data signal from the scan line to be applied to a control terminal of the driving sub-circuit 3.

The emission-control sub-circuit 2 has an input terminal coupled to a first voltage port VDD, a control terminal coupled to an emission-control terminal GC2, and an output terminal coupled to a second node B which is coupled to the driving sub-circuit 3. The emission-control sub-circuit 2 is configured to provide a first voltage signal from the first voltage port VDD to be applied to a first terminal of the driving sub-circuit 3 to set a first voltage level at the first terminal under a control of the emission-control terminal GC2.

The reset sub-circuit 4 has an input terminal coupled to a reset port ofs, a control terminal coupled to a reset-control terminal GC1, and an output terminal coupled to a third node C which is coupled to the capacitor 5 and the driving sub-circuit 3. The reset sub-circuit 4 is configured to provide a reset signal from the reset port ofs to a second terminal of the driving sub-circuit 3 to set a second voltage level at the second terminal under a control of the reset-control terminal GC1.

The capacitor 5 has a first terminal coupled to the first node A (the control terminal of the driving sub-circuit 3) and a second terminal coupled to the third node C (the second terminal of the driving sub-circuit 3). The capacitor 5 is used to regulate a voltage difference between the first node A and the third node C to stabilize the voltage difference therebetween.

The light-emitting device 6 has first electrode coupled to the third node C or the second terminal of the driving sub-circuit 3 and a second electrode coupled to a second voltage port VSS.

The driving sub-circuit 3 has the first terminal coupled to the second node B, the control terminal coupled to the first node A, and the second terminal coupled to the third node C. The driving sub-circuit 3 is configured to, after the second terminal being set to the second voltage level, to drive a light-emitting device 6 under a control of the data signal applied to the control terminal, the first voltage level set at the first terminal, and the voltage difference between the control terminal and the second terminal regulated by the capacitor 5.

In some embodiments, the pixel circuit described herein is able to provide a current of the driving sub-circuit for driving the light-emitting device to be dependent on a voltage of the data signal but independent on a threshold voltage of the driving sub-circuit and the first voltage signal. Thus, the effect of the threshold voltage drift on the light-emitting device is eliminated. In other words, when a same data signal is applied to different subpixels (each subpixel includes a pixel circuit) in a display area of a display apparatus, all display subpixel images will have a same brightness, enhancing overall uniformity of the whole display image in the display area.

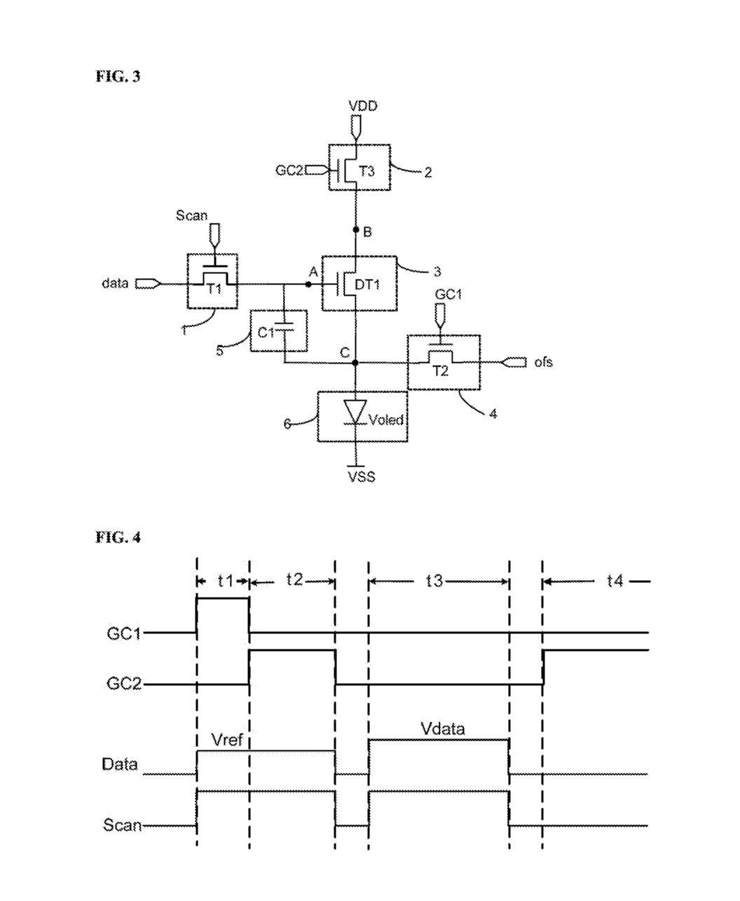

FIG. 3 is a circuit diagram of a pixel circuit according an embodiment of the present disclosure. Referring to FIG. 3, in a specific embodiment the driving sub-circuit 3 includes a driving transistor DT1. The driving transistor DT1 has a gate electrode coupled to the output terminal of the data-input sub-circuit 1, a first electrode coupled to the output terminal of the emission-control sub-circuit 2, and a second electrode coupled to the third node C. The gate electrode is the control terminal of the driving sub-circuit 3. The first electrode and the second electrode are respectively the first terminal and the second terminal of the driving sub-circuit 3. Optionally, as shown in FIG. 3, the driving transistor DT1 is an N-type transistor. Accordingly, for working with the N-type driving transistor DT1, the first voltage signal from the first voltage port VDD corresponds to a positive voltage at a switch-on voltage level and a second voltage signal from the second voltage port VSS corresponds to a ground level or a negative voltage at a switch-off voltage level.

Referring to FIG. 3, the data-input sub-circuit 1 in the pixel circuit includes a first switch transistor TL. The first switch transistor T1 has a gate electrode coupled to a scan line Scan configured to be applied with a first control signal, a first electrode coupled to a data line (data) configured to be provided with a data signal, and a second electrode coupled to the first node A. The gate electrode is the control terminal of the data-input sub-circuit 1. The first electrode is the input terminal of the data-input sub-circuit 1. The second electrode is the output terminal of the data-input sub-circuit 1.

Optionally, as shown in FIG. 3, the first switch transistor T1 is an N-type transistor. When the first control signal, i.e., a scan signal VScan, provided from the scan line Scan is set at a switch-on voltage level, the first switch transistor T1 is in a conduction state. When the scan signal VScan is set to be a switch-off voltage level, T1 is in a non-conduction state. Alternatively, the first switch transistor T1 can be a P-type transistor. Correspondingly, the switch-off voltage level is a high voltage signal that turns off T and the switch-on voltage level is a low voltage signal that turns on T1. In some embodiments, as the first switch transistor T1 is in a conduction state under the control of the first control signal Vscan so that the data signal can be transported from the data line through the first switch transistor T1 to the first node A to reset a voltage level defined by the data signal at the control terminal of the driving sub-circuit 3.

Referring to FIG. 3, the pixel circuit has a second switch transistor T2 having a gate electrode coupled to the reset-control terminal GC1 configured to be applied with a third control signal, a first electrode coupled to the reset port configured to be provided with a reset signal, and a second electrode coupled to the third node C. The gate electrode is the control terminal of the reset sub-circuit 4. The first electrode is the input terminal of the reset sub-circuit 4. The second electrode is the output terminal of the reset sub-circuit 4. Optionally, the second switch transistor T2 is an N-type transistor which is turned on by a switch-on signal at the high voltage level set for the third control signal from the reset-control terminal GC1 or turned off by a switch-off signal at the low voltage level thereof. Alternatively, the second switch transistor T2 can be a P-type transistor and can be turned on or off by a low or high voltage level of the third control signal from the reset-control terminal GC1. In some embodiments, as the second switch transistor T2 is in a conduction state under the control of the switch-on voltage level set for the third control signal from the reset-control terminal GC1, a reset signal can be transported through the second switch transistor the second switch transistor T2 to the third node C to reset a voltage level defined by the reset signal at the second terminal of the driving sub-circuit 3.

Referring to FIG. 3 again, the emission-control sub-circuit 2 in the pixel circuit also includes a third switch transistor T3. The third switch transistor T3 has a gate electrode coupled to the emission-control terminal GC2 configured to be applied with a second control signal, a first electrode coupled to the first voltage terminal VDD configured to be supplied with a first voltage signal, and a second electrode coupled to the second node B. The gate electrode is the control terminal of the emission-control sub-circuit 2. The first electrode is the input terminal of the emission-control sub-circuit 2. The second electrode is the output terminal of the emission-control sub-circuit 2. Optionally, the third switch transistor T3 is an N-type transistor which is turned on by a switch-on signal at the high voltage level set for the second control signal from the emission-control terminal GC2 or turned off by a switch-off signal at the low voltage level thereof. Alternatively, the third switch transistor T3 can be a P-type transistor and can be turned on or off by a low or high voltage level of the second control signal from the emission-control terminal GC2. In some embodiments, as the third switch transistor T3 is in a conduction state under the control of the second control signal at the switch-on voltage level, the first voltage signal from the first voltage port VDD can be transported through the third switch transistor T3 to charge the second terminal of the driving transistor DT1 to determine a voltage level at the third node C.

Referring to FIG. 3, the light-emitting device 6 is a light-emitting diode (LED) device having a first electrode coupled to the third node C or the second electrode of the driving transistor DT1 and a second electrode coupled to the second voltage port VSS. Optionally, the light-emitting device 6 is an organic light-emitting diode (OLED) device. Optionally, the second electrode of the OLED device is configured to be set at a switch-off voltage level provided with the second voltage port VSS to allow a driving current determined by the driving transistor DT1 to drive the OLED to emit light.

Further referring to FIG. 3, the capacitor 5 of the pixel circuit of FIG. 2 is the capacitor C1 having a first terminal coupled to the node A (or the gate electrode of the driving transistor DT1) and a second terminal coupled to the third node C (or the second electrode of the driving transistor DT1). In some embodiments, when the driving transistor DT1, the first switch transistor T1, and the third switch transistor T3 are turned on respectively by a switch-on signal but the second switch transistor T2 is turned off by a switch-off signal, the first node A or the gate electrode of DT1 will be set at a voltage level Vref defined by the data signal from the data line, i.e., the voltage level at the gate electrode of DT1 is V_{G}=Vref The first voltage signal from the first voltage port VDD is charging the third node C or the second electrode of DT1 up to a voltage level of V_{G}−Vₜₕ=Vref−Vₜₕ, where the Vₜₕ is the threshold voltage of the driving transistor DT1. When the driving transistor DT1 and the third switch transistor T3 are turned on respectively by a switch-on signal and the first switch transistor T1 and the second switch transistor T2 are turned off respectively by a switch-off signal, the first node A will be set at a voltage level Vdata defined by the data signal provided to the data line at this time. Because of a bootstrap effect of the capacitor, the voltage level at the third node C will be changed to V_{S}=Vref−Vₜₕ+ΔV, where ΔV is a partial voltage of Vdata−Vref applied to both the capacitor C1 and the light-emitting device 6. In other words, ΔV−C1/(C1+Coled)×(Vdata−Vref). Here C1 is also denoted as the capacitance of the capacitor C. The light-emitting device 6 is an OLED device which is equivalent to a capacitor having an effective capacitance Coled.

Optionally, the transistors in the pixel circuit described herein can be all N-type transistors or all P-type transistors. Optionally, the driving transistor DT1 and each of the three switch transistors, T1, T2, and T3, can be a thin-film transistor. Optionally, the driving transistor and each switch transistor can be a metal oxide semiconductor (MOS) field-effect transistor. Optionally, the first electrode and the second electrode of each transistor may be interchanged based on transistor types and different control signals in either a switch-on voltage level or a switch-off voltage level. In the forthcoming description of operating the pixel circuit of FIG. 3, the switch-on voltage level is represented by “1” and the switch-off voltage level is represented by “0”.

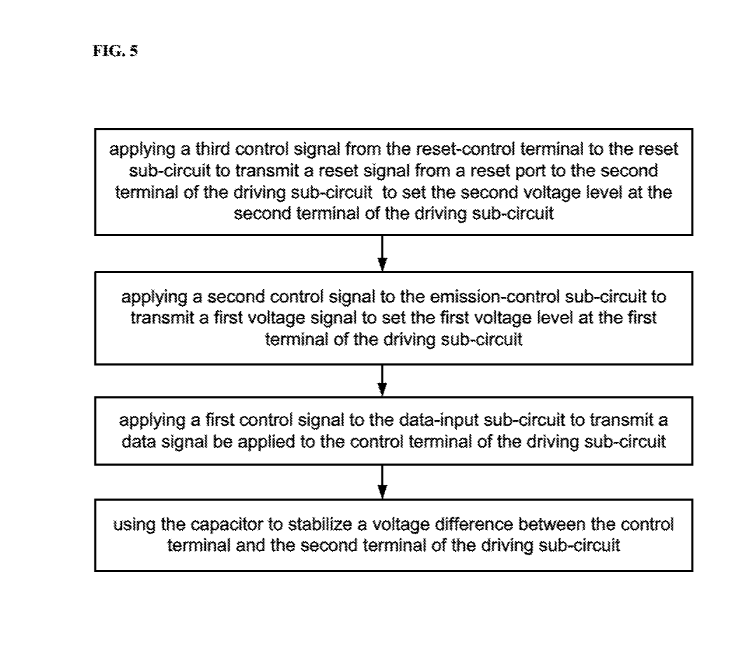

FIG. 4 is a timing diagram of operating the pixel circuit of FIG. 3 according to some embodiments of the present disclosure. Referring to FIG. 4, operating the pixel circuit is performed in an operation cycle including at least four periods, a reset period t1, a compensation period t2, a data-input period t3, and an emission period t4.

In the reset period t1, a first control signal Scan=1, a second control signal GC2=0, and a third control signal GC1=1. The driving transistor DT1, the first switch transistor T1, and the second switch transistor T2 are in conduction state and the third switch transistor T3 is in non-conduction state. A data signal Data is provided from the data line through the first switch transistor T1 to the first node A, i.e., the first node A will be at a voltage level Vdata. In an example, Vdata=Vref during the reset period t1. In this period, a reset signal Vofs is provided from the reset port through the second switch transistor T2 to the third node C, i.e., the third node C will be set at a voltage level Vofs. The reset period t1 is a period within an operation cycle for transmitting the data signal Vdata and the reset signal Vofs respectively to reset the voltage level of the first node A through the first switch transistor T and the voltage level of the third node C through the second switch transistor T2. The data signal in the t1 period is merely a reference signal for resetting the voltage level at the first node A and not necessarily the same as general data signals scanned sequentially through all rows of the pixel circuits in a display panel for displaying a frame of image.

In the compensation period t2, the first control signal Scan=1, the second control signal GC2=1, and the third control signal GC1=0. The driving transistor DT1, the first switch transistor T1, and the third switch transistor T3 are in conduction state and the second switch transistor T2 is in non-conduction state. The data signal is provided from the data line through the first switch transistor T1 to the first node A to set the first node A or the gate electrode of the driving transistor DT1 at a voltage equal to V_{A}=V_{G}=Vdata=Vref. The first voltage signal from the first voltage port VDD is applied through the third switch transistor T3 to the second node B and the first electrode of the driving transistor DT1 to charge the third node C, i.e., the second electrode of the driving transistor DT1 while its gate electrode is set to the voltage level of V_{G}=Vref. Therefore, the charging of the third node C is performed until the second electrode of the driving transistor DT1 reaches a voltage level V_{S}=Vref−Vₜₕ, where Vₜₕ is a threshold voltage of the driving transistor DT1. Optionally, the data signal in the compensation period t2 is the same as Vref of the data signal in the period t1.

In the data-input period t3, the first control signal Scan=1, the second control signal GC2=0, the third control signal GC1=0. The driving transistor DT1 and the first switch transistor T1 are in conduction state and the second switch transistor T2 and the third switch transistor T3 are in non-conduction state. A data signal in this period is provided from the data line through the first switch transistor T1 to the first node A to set the first node A at the voltage level Vdata. Because of a bootstrapping effect of the capacitor C1, the voltage level at the third node C will be changed to V_{C}=Vref−Vₜₕ+ΔV, where ΔV=C1/(C1+Coled)×(Vdata−Vref) is a partial voltage of (Vdata−Vref) applied to both the capacitor C1 and the effective capacitor Coled of the light-emitting device 6. The data signal Vdata in this period is the same as a general scan signal inputted for displaying image.

In the emission period t4, the first control signal Scan=0, the second control signal GC2=1, and the third control signal GC1=0. The driving transistor DT1 and the third switch transistor T3 are in conduction state and the first switch transistor T1 and the second switch transistor T2 are in non-conduction state. The first voltage signal from the first voltage terminal VDD is passed through the third switch transistor T3 to apply to the second node 1 and to generate a driving current through the driving transistor DT1 to drive the light-emitting device OLED to emit light. In this period, the driving current through DT1 is depended upon the voltage difference V_{GS} between the first electrode and the gate electrode of DT1. Here, the gate voltage V_{G} is the same voltage V_{A}=V_{data} at the first node A and the first electrode voltage V_{S} is the same voltage V_{C}=Vref−Vₜₕ+ΔV at the third node C. In other words, the voltage difference V_{GS}=V_{AC}=V_{data}−V_{ref}+Vₜₕ−ΔV. Then the driving current I_{OLED} flowing through the driving transistor DT1 can be represented as:

$$\begin{matrix}{I}_{OLED} = \frac{1}{2} {μ}_{n} Cox {\frac{W}{L} [ Vgs - Vth ]}^{2} \\ = \frac{1}{2} {μ}_{n} Cox {\frac{W}{L} [ Vdata - Vref + Vth + Δ V - Vth ]}^{2} \\ = \frac{1}{2} {μ}_{n} Cox {\frac{W}{L} [ Vdata - Vref + Δ V ]}^{2}\end{matrix}$$

where μₙ is carrier mobility, Cox is capacitance of gate oxide layer, W/L is a width to length ratio of the driving transistor DT1. The driving current I_{OLED} will be directly used for driving the OLED to emit light. The formula above indicates that the driving current is only depended on the data signal Vdata and reset signal Vref, but independent of the threshold voltage Vₜₕ. Therefore, when the data signals applied to different subpixels in the display area of a display apparatus are the same, the different subpixels having the pixel circuits of the present disclosure will generate images with the same brightness, enhancing brightness uniformity of the display area of the display apparatus. The pixel circuit of the present disclosure has only four transistors and one capacitor to achieve its function for driving the OLED to emit light and can be used to make high-pixel number display panels.

In another aspect, the present disclosure provides a method of driving the pixel driving circuit described herein. FIG. 5 is a flow chart showing a method of driving a pixel circuit according to some embodiments of the present disclosure. Referring to FIG. 5, the method includes operating the pixel circuit in an operation cycle including reset period, a compensation period, a data-input period, and an emission period for displaying a frame of image. In the reset period, the method includes applying a third control signal at the reset-control terminal to control the reset sub-circuit of the pixel circuit to pass a reset signal from a reset port the third node and applying a first control signal at the scan line to control the data-input sub-circuit of the pixel circuit to pass a reference signal from the data line to the first node. In the compensation period, the method further includes applying a second control signal to the emission-control terminal to control the emission-control sub-circuit to allow a first voltage to be passed to the second node and further to charge the third node and applying the first control signal at the scan line to control the data-input sub-circuit to pass the reference signal to the first node to turn on the driving sub-circuit. In the data-input period, the method furthermore includes applying the first control signal at the scan line to control the data-input sub-circuit to pass a data signal to the first node and using the capacitor to stabilize a voltage difference between the first node and the third node. In the emission period, the method moreover includes applying the second control signal to the emission-control terminal of the emission-control sub-circuit to pass the first voltage to the second node and using the capacitor to stabilizing the voltage difference between the first node and the third node to control an output current of the driving sub-circuit at the third node to drive the light-emitting device to emit light.

In some embodiments, the first control signal is set to a high voltage level in the reset period, the compensation period, and the data-input period, and a low voltage level in the emission period. The second control signal is set to a low voltage level in the reset period and the data-input period, and a high voltage level in the compensation period and the emission period. The third control signal is set to a high voltage level in the reset period, and a low voltage level in the compensation period, the data-input period, and the emission period. In the embodiments, the third node is charged to a voltage level equal to a first difference between the reference signal and a threshold voltage of the driving transistor of the driving sub-circuit in the compensation period.

In some embodiments, the voltage difference between the first node and the third node in the data-input period is stabilized at the first difference plus a partial voltage level that is equal to the first difference multiplied by a ratio of a capacitance of the capacitor over a sum of the capacitance of the capacitor and an effective capacitance of the light-emitting device.

in some embodiments, the output current of the driving sub-circuit in the emission period is independent from the threshold voltage of the driving transistor.

In another aspect, the present disclosure also provides a display panel including a plurality of sub-pixels arranged in an array of matrix each of which includes a pixel circuit described herein. Each row of pixel circuits is coupled to one corresponding scan line. The emission-control terminal of each pixel circuit is commonly connected to a second control line and the reset-control terminal of each pixel circuit is commonly connected to a third control line. In an embodiment, the display panel is an organic light-emitting diode display panel. Each pixel circuit includes an organic light-emitting diode driven by an output current of a driving transistor for emitting light, the output current being independent from a threshold voltage of the driving transistor.

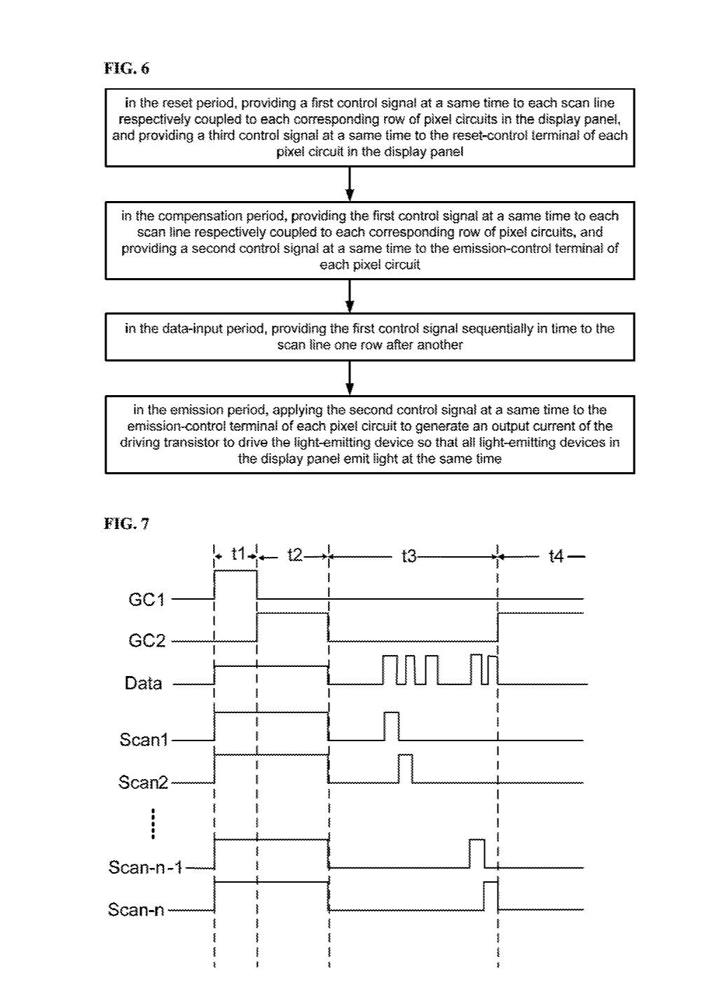

In yet another aspect, the present disclosure provides a method of driving a display panel described herein. FIG. 6 is a flow chart showing a method of operating an organic light-emitting diode display panel for displaying image according to some embodiments of the present disclosure. Referring to FIG. 6, the method includes applying a first control signal from the scan line to the gate electrode of the first switch transistor of the data-input sub-circuit to transmit a data signal be applied to the control terminal of the driving sub-circuit. The method further includes applying a third control signal from the reset-control terminal to the gate electrode of the second switch transistor to transmit a reset signal from a reset port to the second electrode of the driving transistor to set the second voltage level at the second terminal of the driving sub-circuit. Additionally, the method includes applying a second control signal from the scan line to the gate electrode of the third switch transistor of the emission-control sub-circuit to transmit a first voltage signal to set the first voltage level at the first terminal of the driving sub-circuit. Furthermore, the method includes using the capacitor to stabilize a voltage difference between the control terminal and the second terminal of the driving sub-circuit.

Optionally, the method of driving the pixel circuit includes operating the pixel circuit in an operation cycle including at least a reset period, a compensation period, a data-input period, and an emission period for displaying a frame of image. In an embodiment, the method of applying a first control signal includes setting the first control signal to be at a switch-on voltage level in the reset period, the compensation period, and the data-input period, and setting the first control signal to be at a switch-off voltage level in the emission period. Additionally, the method of applying a second control signal includes setting the second control signal to be at a switch-off voltage level in the reset period and the data-input period, and setting to be at a switch-on voltage level in the compensation period and the emission period. Furthermore, the method of applying a third control signal comprises setting the third control signal to be at a switch-on voltage level in the reset period, and setting the third control signal to be at a switch-off voltage level in the compensation period, the data-input period, and the emission period.

In an embodiment, the method of driving the pixel circuit is applied to drive each of a plurality of pixel circuits respectively disposed in a display panel. Pixel circuits in each row are commonly coupled to a scan line configured to receive a first control signal. All emission-control terminals of the emission-control sub-circuits respectively in the plurality of pixel circuits in the display panel are commonly connected. All reset-control terminals of the reset sub-circuits respectively in the plurality of pixel circuits in the display panel are commonly connected. In the reset period of an operation cycle, the method of driving a pixel circuit described above includes providing a first control signal at a same time to each scan line respectively coupled to each corresponding row of pixel circuits in the display panel and providing a third control signal at a same time to the reset-control terminal of each pixel circuit in the display panel. In the compensation period, the method includes providing the first control signal at a same time to each scan line respectively coupled to each corresponding row of pixel circuits and providing a second control signal at a same time to the emission-control terminal of each pixel circuit. In the data-input period, the method includes providing the first control signal sequentially in time to the scan line one row after another. In the emission period, the method includes applying the second control signal at a same time to the emission-control terminal of each pixel circuit to generate an output current of the driving transistor to drive the light-emitting device so that all light-emitting devices in the display panel emit light at the same time for displaying the frame of image.

FIG. 7 is a timing diagram of operating an organic light-emitting diode display panel for displaying image according to some embodiments of the present disclosure. Referring to FIG. 7, the timing diagram shows an organic light-emitting diode display panel in an operation cycle for displaying a frame of image. The operation cycle includes the reset period t1, a compensation period t2, a data-input period t3, and an emission period t4. During the operation, each of the third control signal provided from the reset-control terminal GC1 and the second control signal provided from the emission-control terminal GC2 is a common signal for all pixel circuits in the display panel.

In the t1 period, the reset-control terminal GC1 provides the third control signal, a common signal, for all pixel circuits in the display panel to reset the voltage level at the third node C of each pixel circuit. In this period, each data line provides a data signal for each corresponding pixel circuit to reset the voltage level at the first node A thereof.

In the t2 period, the emission-control terminal GC2 provides the second control signal, a common signal, for all pixel circuits in the display panel to charge the third node C of each pixel circuit. In this period, each data line provides a data signal to each corresponding pixel circuit to maintain the voltage level at the first node thereof.

In the t3 period, each scan line sequentially provides a Scan signal to each (row) corresponding pixel circuit(s). Referring to FIG. 7, a first scan line Scan1 provides a first scan signal (represented as a first pulse in t3 period in FIG. 7) to a first (row) pixel circuit(s), followed by a second scan line Scan2 providing a second scan signal to a second (row) pixel circuit(s), and so on, till the last or n-th scan line Scan-n providing a n-th scan signal to the n-th (row) pixel circuit(s). Each data line provides a data signal to each corresponding pixel circuit.

In the t4 period, the emission-control terminal GC2 provides the second control signal, a common signal, to all pixel circuits in the display panel to drive light emission in all subpixels at the same time.

In t1, t2, and t3 period, the whole screen of the display panel does not emit light. During the t1 and t2 periods, both the reset-control signal from GC1 and the emission-control signal from GC2 are common signals for all pixel circuits in the display panel so that the method of operating the organic light-emitting diode display panel is performed at the same time for the whole display panel. After the data-input period t3, the emission-control signal from GC2 is provided as a common signal at the high voltage level for all pixel circuits, driving all subpixels in the whole display panel to emit light at the same time.

In the embodiment for executing the method of operating the display panel, assuming that all transistors in each pixel circuit are N-type transistors, the first control signal is set to a high voltage level in the reset period, the compensation period, and the data-input period, and a low voltage level in the emission period; the second control signal is set to a low voltage level in the reset period and the data-input period, and a high voltage level in the compensation period and the emission period; the third control signal is set to a high voltage level in the reset period, and a low voltage level in the compensation period, the data-input period, and the emission period, the driving current to driving each light-emitting device is independent from a threshold voltage of the corresponding driving transistor in each pixel circuit.

In the embodiment, the whole display panel does not emit light during the reset period, the compensation period, and the data-input period. Because both the third control signal as a reset signal and the second control signal as an emission-control signal are common signal for entire display panel, the operation for each pixel circuit in the reset period and compensation period are performed for entire display panel at the same time. Operations in the data-input period are performed to input data signal scanning sequentially from one row to next row. After scanning through all rows of the entire display panel, in the emission period, only the second control signal, i.e., the emission-control signal, is at high voltage level applied to the pixel circuit of each sub-pixel, all sub-pixels the entire display panel emit light at the same time.

In still another aspect, the present disclosure provides a display apparatus including the organic light-emitting display panel described herein. The display apparatus can be any one of a display, a smart phone, a television, a notebook computer, an electronic paper, a digital frame, a navigator, or one machine having a display function.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A pixel circuit in a display panel comprising:
a data-input sub-circuit coupled to a capacitor and a driving sub-circuit, and configured to transmit a data signal be applied to a control terminal of the driving sub-circuit;
an emission-control sub-circuit coupled to the driving sub-circuit, and configured to supply a first voltage signal be applied to a first terminal of the driving sub-circuit to set a first voltage level at the first terminal;
a reset sub-circuit coupled to capacitor and the driving sub-circuit, and configured to transmit a reset signal be supplied to a second terminal of the driving sub-circuit to set a second voltage level at the second terminal;
wherein the driving sub-circuit is configured, after the second terminal being set to the second voltage level, to drive a light-emitting device which is coupled to the second terminal under a control of the data signal applied to the control terminal, the first voltage level set at the first terminal, and the voltage difference between the control terminal and the second terminal regulated by the capacitor.

2. The pixel circuit of claim 1, wherein the driving sub-circuit comprises a driving transistor having a gate electrode coupled to an output terminal of the data-input sub-circuit, a first electrode coupled to an output terminal of the emission-control sub-circuit, and a second electrode coupled to an output terminal of the reset sub-circuit, wherein the gate electrode is the control terminal, the first electrode is the first terminal, and the second electrode is the second terminal.

3. The pixel circuit of claim 1, wherein the data-input sub-circuit comprises a first switch transistor having a gate electrode coupled to a scan line configured to be applied with a first control signal, a first electrode coupled to a data line configured to be provided with the data signal, and a second electrode coupled to the control terminal of the driving sub-circuit.

4. The pixel circuit of claim 1, wherein the reset sub-circuit comprises a second switch transistor having a gate electrode coupled to a reset-control terminal configured to be applied with a third control signal, a first electrode coupled to a reset port configured to be provided with the reset signal, and a second electrode coupled to the second terminal of the driving sub-circuit.

5. The pixel circuit of claim 1, wherein the emission-control sub-circuit comprises a third switch transistor having a gate electrode coupled to a emission-control terminal configured to be applied with a second control signal, a first electrode coupled to a first voltage terminal configured to be provided with a first voltage signal, and a second electrode coupled to the second terminal of the driving sub-circuit.

6. The pixel circuit of claim 1, wherein the light-emitting device comprises an organic light-emitting diode having a first electrode coupled to the second terminal of the driving sub-circuit and a second electrode coupled to a second voltage terminal.

7. The pixel circuit of claim 1, wherein the data-input sub-circuit comprises a first switch transistor, the reset sub-circuit comprises a second switch transistor, and the emission-control sub-circuit comprises a third switch transistor, each of the first switch transistor, the second switch transistor, and the third switch transistor is an N-type thin-film transistor or N-type MOS transistor.

8. A method of driving a pixel circuit of claim 1, the method comprising:
applying a third control signal from the reset-control terminal to the reset sub-circuit to transmit a reset signal from a reset port to the second terminal of the driving sub-circuit to set the second voltage level at the second terminal of the driving sub-circuit;
applying a second control signal to the emission-control sub-circuit to transmit a first voltage signal to set the first voltage level at the first terminal of the driving sub-circuit;
applying a first control signal to the data-input sub-circuit to transmit a data signal be applied to the control terminal of the driving sub-circuit; and
using the capacitor to stabilize a voltage difference between the control terminal and the second terminal of the driving sub-circuit.

9. The method of claim 8, wherein the applying a first control signal comprises setting the first control signal to be at a switch-on voltage level in a reset period, a compensation period, and a data-input period of an operation cycle of the pixel circuit, and setting the first control signal to be at a switch-off voltage level in an emission period of the operation cycle.

10. The method of claim 9, wherein the applying a second control signal comprises setting the second control signal to be at a switch-off voltage level in the reset period and the data-input period, and setting to be at a switch-on voltage level in the compensation period and the emission period.

11. The method of claim 10, wherein the applying a third control signal comprises setting the third control signal to be at a switch-on voltage level in the reset period, and setting the third control signal to be at a switch-off voltage level in the compensation period, the data-input period, and the emission period.

12. The method of claim 11, wherein in the reset period the data signal comprises a reference voltage being applied to the gate electrode of the driving transistor and the reset signal comprises a reset voltage being applied to the second electrode of the driving transistor, the reset voltage being equal to the reference voltage.

13. The method of claim 11, wherein in the compensation period the data signal comprises a reference voltage being applied to the gate electrode of the driving transistor, the method further comprising applying the first voltage signal from the first voltage port to the first electrode of the driving transistor to charge the second electrode of the driving transistor.

14. The method of claim 13, wherein the second electrode of the driving transistor is charged to a voltage level equal to a first voltage difference between the reference voltage and a threshold voltage of the driving transistor.

15. The method claim 14, wherein in the data-input period the using the capacitor comprises stabilizing a second voltage difference between the control terminal and the second terminal of the driving sub-circuit equal to the first difference plus a partial voltage level that is equal to the first difference multiplied by a ratio of a capacitance of the capacitor over a sum of the capacitance of the capacitor and an effective capacitance of the light-emitting device.

16. A display panel comprising an array of pixel circuits, each of which is a pixel circuit of claim 1 coupled to a light-emitting device.

17. The display panel of claim 16, wherein each of the array of pixel circuits comprises an emission-control sub-circuit having a common emission-control terminal and a reset sub-circuit having a common reset-control terminal.

18. A display apparatus comprising a display panel of claim 16.
